(19) United States
(12) Patent Application Publication
(10) Pub. No.: US 2015/0039702 A1
(43) Pub. Date: Feb. 5, 2015

(54) SYSTEM AND METHOD FOR MONITORING A HUB-BASED SYSTEM FEDERATING DISPARATE UNIFIED COMMUNICATIONS SYSTEMS

(71) Applicant: NextPlane, Inc., Sunnyvale, CA (US)

(72) Inventors: Sanjay Pujare, San Jose, CA (US); Saravana Bellan, San Jose, CA (US); Yogesh Raina, Cupertino, CA (US); Farzin Shahidi, Los Altos Hills, CA (US)

(73) Assignee: NextPlane, Inc., Sunnyvale, CA (US)

(21) Appl. No.: 13/959,692

(22) Filed: Aug. 5, 2013

(51) Int. Cl. H04L 12/58

(52) U.S. Cl. CPC H04L 51/36
USPC 709/206

(57) ABSTRACT

An apparatus for monitoring a hub-based federation system. The apparatus includes a message generator, a first connector, a second connector, and a status manager. The message generator is configured to generate a first message based on a first communications protocol. The first connector is configured to send the first message to a hub via the first communications protocol. The hub federates a plurality of unified communications systems. The second connector is configured to receive a second message from the hub via a second communications protocol. The status manager is configured to analyze the second message to determine status information regarding the hub-based federation system.

### RELATED FIELD

The present disclosure relates in general to interconnecting unified communications systems, and in particular, to a system and method for monitoring a hub that interconnects disparate unified communications systems in a federated manner.

### BACKGROUND

A unified communications (“UC”) system generally refers to a system that provides users with an integration of communications services. Users typically connect to the UC system through a single client to access the integrated communications services. The integrated communications services may include real-time services, such as instant messaging (IM), presence notifications, telephony, and video conferencing, as well as non-real-time services, such as E-mail, SMS, fax, and voicemail.

Organizations, such as corporations, businesses, educational institutions, and government entities, often employ UC systems to enable internal communication among its members in a uniform and generally cost-efficient manner. In addition, organizations may employ UC systems for communicating with trusted external entities.

A number of third-party developers offer various UC applications for implementing UC systems. The various applications include Microsoft Lync (previously, Microsoft Office Communications Server (OGS)), IBM Sametime (ST), Google Apps, and Cisco Jabber. Because there is no industry standard regarding UC systems, issues of incompatibility arise when one UC system needs to communicate with a different UC system. In one case, a corporation or business that employs a particular UC system may desire to communicate externally with vendors or other persons who employ a different UC system. Or in the case of internal communication, when an organization that employs a particular UC system “A” merges with another organization that employs a UC system “B”, the ability for users on system “A” to communicate with users on system “B” is often desirable. Nevertheless, the incompatibility of the UC systems often makes communication between the UC systems difficult or impossible to implement.

Co-pending U.S. patent application Ser. No. 13/077,710 entitled “Hub Based Clearing House For Interoperatbility Of Distinct Unified Communications Systems” and U.S. patent application Ser. No. 13/153,025 entitled “Method And System For Advanced Alias Domain Routing,” incorporated by reference herein, describe a highly scalable, hub-based system for interconnecting, or federating, any number of disparate UC systems. The hub-based system includes a hub that allows users on one UC system to communicate with users of another UC system as if they were served by like or similar UC systems, regardless of whether the UC systems are of the similar or different type. Generally, if the hub operates improperly or is out of operation entirely, it may halt or adversely affect communication between the users on the different UC systems. For example, one or more server components may crash with out-of-memory errors, an SIP stack may become stuck because one of the outgoing connections hung, etc. Therefore, there exists a need for a system and method to monitor the status of the hub to detect existing issues and/or anticipate potential future issues.

### SUMMARY

An apparatus for monitoring a hub-based federation system. The apparatus includes a message generator, a first connector, a second connector, and a status manager. The message generator is configured to generate a first message based on a first communications protocol. The first connector is configured to send the first message to a hub via the first communications protocol. The hub federates a plurality of unified communications systems. The second connector is configured to receive a second message from the hub via a second communications protocol. The status manager is configured to analyze the second message to determine status information regarding the hub-based federation system.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates a block diagram of an exemplary hub-based architecture implementing a monitoring system and federating disparate UC systems, according to one embodiment;

FIG. 2 illustrates an exemplary implementation of a monitoring system, according to one embodiment;

FIG. 3 illustrates an exemplary SRV record associating a monitoring system with two hub instances, according to one embodiment;

FIG. 4 illustrates a flow diagram of exemplary operations of a monitoring system having an SIP connector and an XMPP connector for monitoring a hub, according to one embodiment;

FIG. 5 illustrates a block diagram of an exemplary monitoring system, according to one embodiment; and

FIG. 6 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAIL DESCRIPTION

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

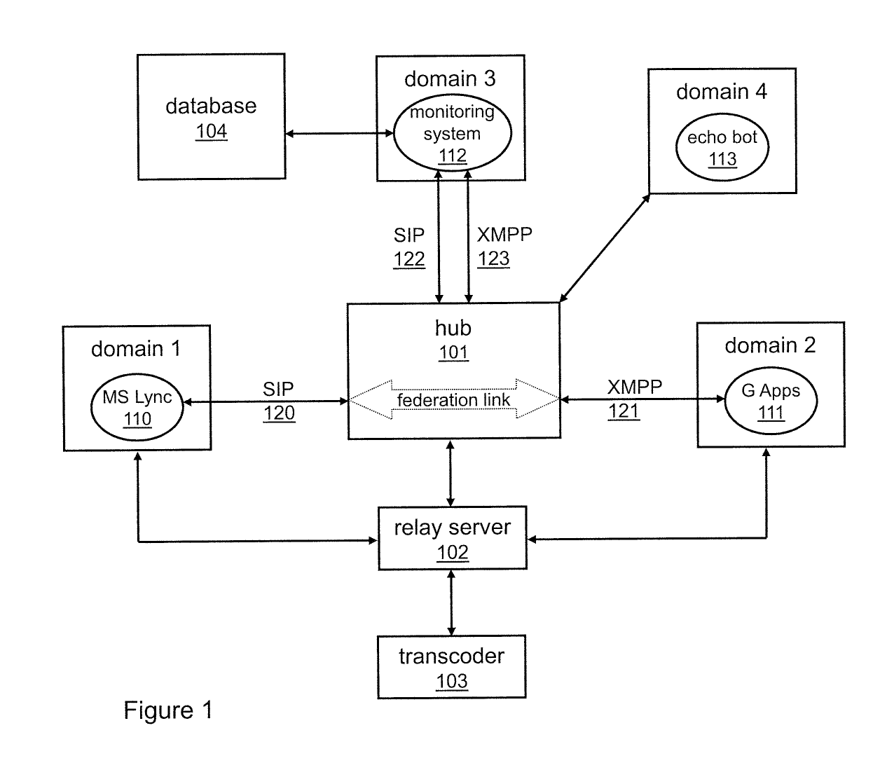

FIG. 1 illustrates a block diagram of an exemplary hub-based architecture implementing a monitoring system and federating disparate UC systems, according to one embodiment. The hub 101 is connected to and communicates with UC systems 110 and 111 that serve their own respective domains. The hub 101 generally includes different connectors to support different communications protocols, such as SIP (Session Initiation Protocol) and XMPP (Extensible Messaging and Presence Protocol). For example, the UC system 110 running Microsoft Lync communicates with hub 101 via a SIP interface 120 while the UC system 111 communicates with the hub 101 via an XMPP interface 121. A federation link established between UC systems 110 and 111 via the hub 101 allows users on one UC system to communicate or interact with users on the other UC system as if all the users are served by like or similar UC systems.

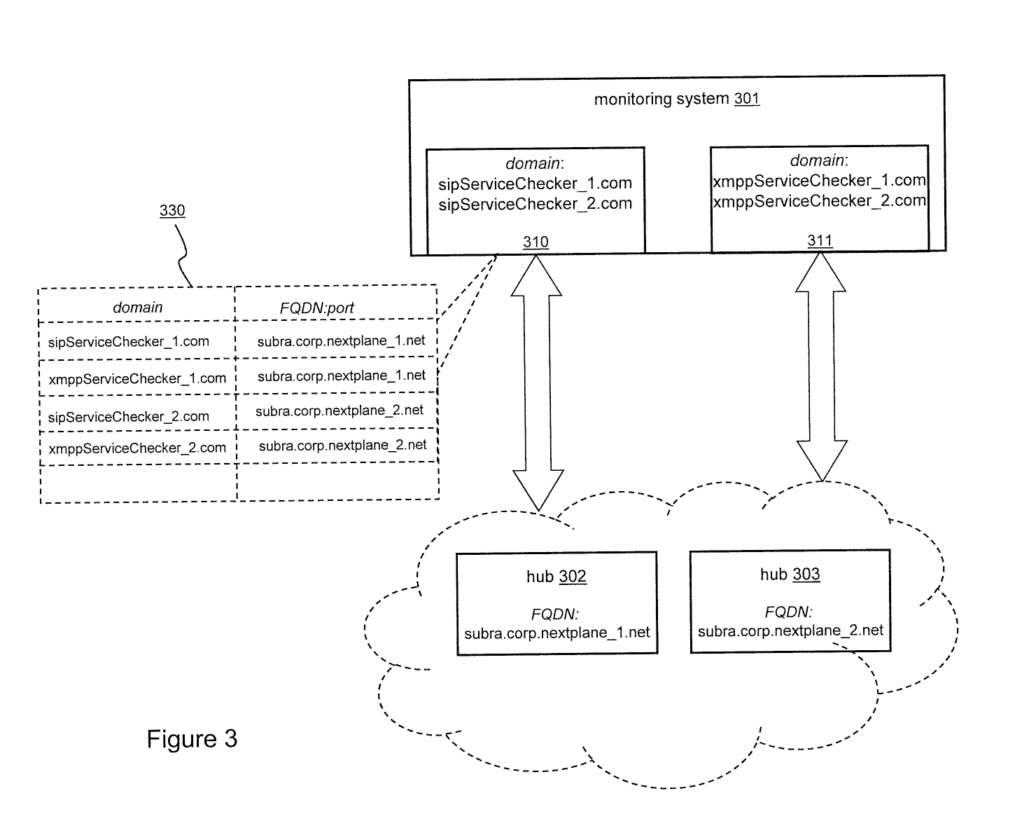

The hub 101 also communicates with the monitoring system 112. According to one embodiment, the monitoring system 112 communicates with the hub 101 to monitor the status (e.g., operational statistics) of the hub 101 and other systems (e.g., UC systems 110-111, relay server 102, transcoder 103, echo bot 113) that are in communication with the hub 101. The monitoring system 112 also includes different connectors (e.g., SIP connector, XMPP connector) to support the different communications protocols and is configured to communicate with the hub 101 via each of the communications protocols. Each connector may be associated with one or more domains that are unique to the connector. Communicating via each of the supported communications protocols simulates communications traffic between the hub 101 and various UC systems and allows the monitoring system 112 to determine whether the hub's connectors are operating properly. For example, the monitoring system 112 may synthesize and send an SIP message through its SIP connector to the hub 101. The synthesized message may include an indicator (e.g., in the message header) that informs the hub 101 that the message is a request for status information. Recognizing the message is a request for information, the hub 101 may then process the SIP message and translate it into an XMPP message before forwarding the XMPP message back to the monitoring system 112 (through its XMPP connector). Vice versa, the monitoring system 112 may send an XMPP message through its XMPP connector and receive an SIP message through its SIP connector. The hub 101 may process the message by inserting status information regarding the hub 101, the relay server 102, the UC systems 110-111, and/or the echo bot 113 into the message. The monitoring system 112 may send heartbeat emails to a user to indicate that the monitoring system 112 is operating properly. A user may configure when and/or how often heartbeat emails are sent (e.g., every 5 minutes). The monitoring system 112 also communicates with a database 104 to store the status information received from the hub. As shown below in FIG. 3, the monitoring system 112 may communicate with and monitor multiple hubs.

The hub 101 also communicates with the relay server 102. The relay server 102 generally relays real-time media traffic, such as audio and video data, (e.g., via RTP or Real-time Transport Protocol) between users who are served by different UC systems, such as UC systems 110 and 111. Because a user generally interacts with a UC system through a user client device (“client”), the terms “user” and “client” are used interchangeably in this disclosure. If the relay server 102 determines that the users' clients have at least one common media codec that is available to each client, relay server 102 relays the media traffic between the users. If there is no common codec, the relay server 102 engages the transcoder 103 to transcode the real-time media traffic relayed by the relay server 102. According to one embodiment, the transcoder 103 may periodically, and/or when requested, send status information for the transcoder 103 to the relay server 102 where the status information may be stored for a period of time. Similarly, the relay server 102 may periodically, and/or when requested, send status information for the relay server 102 and the stored status information for the transcoder 103 to the hub 101 where the status information may be stored for a period of time.

According to one embodiment, the hub 101 may gather status information for various UC systems by detecting communications traffic to those UC systems and logging certain events. For example, suppose a user from the UC system 110 attempts to contact another user at the UC system 111 by sending a message through the hub 101. If the hub 101 detects that communication cannot be established with the second UC system 111, the hub 101 may log the UC system 111 and/or its associated domain as unresponsive.

An echo bot generally refers to an automated system that simulates the interactions and/or operations of a UC system. For example, similar to a UC system, the echo bot 113 and its associated domain may be provisioned with the hub 101 through a provisioning process that establishes a connection with the hub 101. Once provisioned with the hub 101, administrators of UC systems 110-111 may federate their UC systems with the echo bot 113 to create a federation link to enable users of the UC systems to communicate with the echo bot 113. Unlike a typical UC system, responses from the echo bot 113 may not originate from human users. Instead, the responses may originate from predefined logic or artificial intelligence in the echo bot 113. Federating with and exchanging messages with the echo bot 113 enables users of a UC system to test its connection to the hub 101 and other potential UC systems.

According to one embodiment, the hub 101 may gather status information for one or more echo bots by detecting communications traffic to those echo bots and logging certain events. For example, suppose the echo bot 113 is federated with the UC system 110 and a user of the UC system 110 adds the echo bot 113 to his contact list. Further suppose that the user from the UC system 110 sends a message to the echo bot 113 through the hub 101 to test his connection to the hub 101. If the hub 101 detects that communication cannot be established with the echo bot 113, the hub 101 may log the echo bot 113 and/or its associated domain as unresponsive. According to another embodiment, the monitoring system 112 may generate and send messages (e.g., periodically) to the echo bot 113 (or to the domain associated with the echo bet 113) to determine whether the echo bot 113 or its underlying bot framework is operating properly. This allows the monitoring system 112 to detect operational irregularities (e.g., unresponsiveness) of the echo bot 113 before a user attempts to contact the echo bot 113. Although FIG. 1 only illustrates one relay server 102, one transcoder 103, and monitoring system 112, the foregoing discussion generally applies to a hub-based architecture that is associated with any number of these elements. Furthermore, the hub 101 is highly-scalable and may support any number and/or type of UC systems and echo bots.

### Implementing the Monitoring System

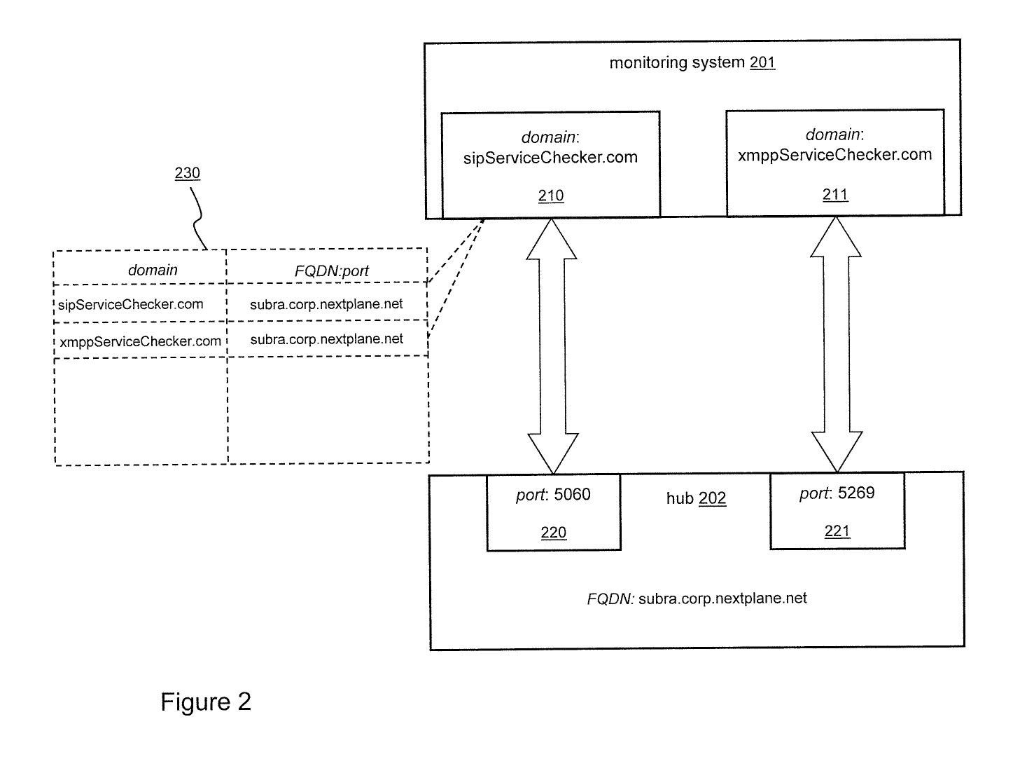

According to one embodiment, a monitoring system may be implemented by associating each of its connectors with one or more domains (hereafter “connector domains”) that are unique to each connector. FIG. 2 illustrates an exemplary implementation of a monitoring system, according to one embodiment. The monitoring system's SIP connector 210 may be associated with the SIP domain “sipServiceChecker.com” and its XMPP connector 211 may be associated with the XMPP domain “xmppServiceChecker.com.” For example, the hub 202 and the monitoring system 201 may be configured in such a way that when the hub 202 sends SIP messages to the domain “sipServiceChecker.com,” the SIP messages are received at the monitoring system's SIP connector 210. Similarly, when the hub 202 sends XMPP messages to the domain “xmppServiceChecker.com,” the XMPP messages are received at the monitoring system's XMPP connector 211.

Furthermore, the monitoring system 201 may associate the connector domains with an FQDN (Fully Qualified Domain Name) of the hub 202 (e.g., “subra.corp.nextplane.net”), such as by publishing an SRV record 230, to route messages addressed to the connectors through hub 202. For example, if the monitoring system 201 sends an SIP message (from its SIP connector 210) addressed to “xmppServiceChecker.com,” the message is routed through the hub's SIP connector 220 (e.g., via port 5060) for processing (e.g., translating, reformatting, and inserting status information) at the hub 202 before being forwarded to the monitoring system's XMPP connector 211. Similarly, if the monitoring system 201 sends an XMPP message (from its XMPP connector 211) addressed to “sipServiceChecker.com,” the message is routed through the hub's XMPP connector 221 (e.g., via port 5269) for processing at the hub 202 before being forwarded to the monitoring system's SIP connector 210.

Besides publishing an SRV record 230, the monitoring system 201 may associate the connector domains with the hub's FQDN using a DNS configuration or override feature in the monitoring system 201 and/or hub 202. For example, the monitoring system 201 or the hub 202 may maintain a mapping of each of the connector domains to the hub's FQDN and port numbers. Although FIG. 2 illustrates the monitoring system 202 as having one SIP connector and one XMPP connector, it is contemplated that a monitoring system can have any number and/or type of connectors.

According to one embodiment, a monitoring system may monitor a plurality of hub instances by associating different connector domain names with each hub instance. FIG. 3 illustrates an exemplary SRV record associating a monitoring system 301 with two hub instances 302 and 303. The monitoring system 301 has two connectors, one SIP connector 310 addressed by domains:

sipServiceChecker_{—1}.com

sipServiceChecker_{—2}.com

and one XMPP connector 311 address by domains:

xmppServiceChecker_{—1}.com

xmppServiceChecker_{—2}.com

The SRV record associates domains “sipServiceChecker_{—}1.com” and “xmppServiceChecker_{—}1.com” with the hub 302 having FQDN: “subra.corp.nextplane_{—}1.net” and domains “sipServiceChecker_{—}2.com” and “xmppServiceChecker_{—}2.com” with the hub 303 having FQDN: “subra.corp.nextplane_{—}2.net.” Associating different sets of domain names with different hub instances allows the monitoring system 301 to distinguish the messages sent and received from the different hub instances, and thus, to figure out which hub instances are being monitored.

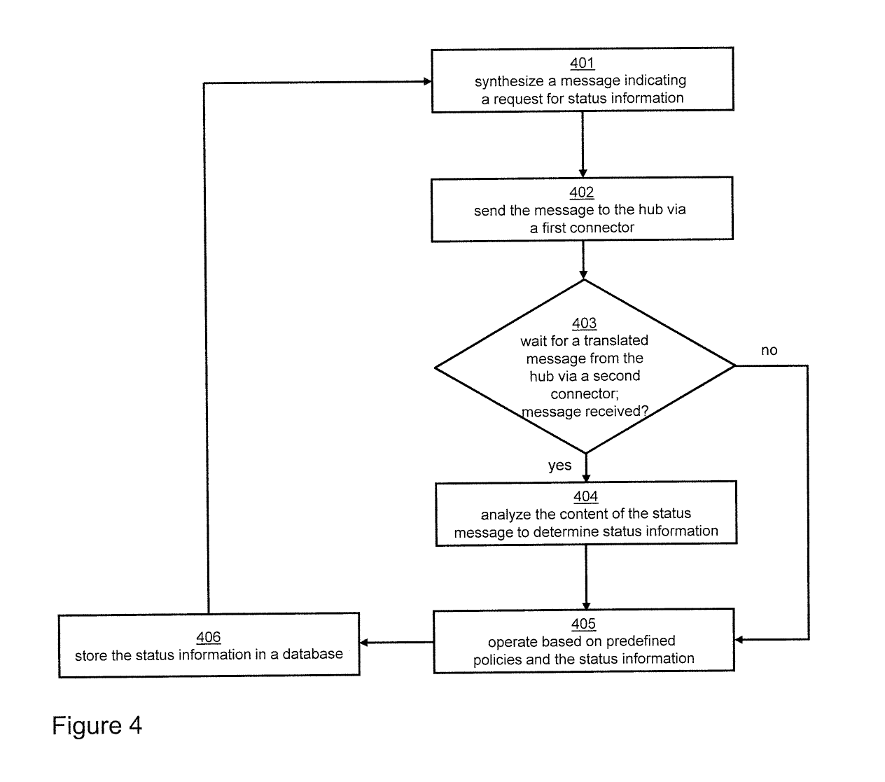

FIG. 4 illustrates a flow diagram of exemplary operations of a monitoring system having an SIP connector and an XMPP connector for monitoring a hub, according to one embodiment. The monitoring system synthesizes a message (SIP or XMPP) at 401. The synthesized message includes an identifier in its header to indicate to the hub that the message is a request for status information from the hub. The synthesized message is addressed to a domain of a monitoring system connector that supports a communications protocol different from the message type. For example, if the message is an SIP message, the message is addressed to a domain associated with the monitoring system's XMPP connector. Vice versa, if the message is an XMPP message, the message is addressed to a domain associated with the monitoring system's SIP connector. The message is sent at 402 via a first connector (e.g., SIP connector) of the monitoring system. As discussed above in regards to FIG. 2, because the connector domains of the monitoring systems are associated with the hub's FQDN (e.g., by publishing an SRV record and/or DNS override feature of the monitoring system or hub), the message is routed to the hub.

If the hub receives the message and recognizes that the message is a request for status information, the hub processes the message by inserting status information (e.g., regarding the hub, the relay server, the UC systems, and/or the echo bot) into the message (hereafter “status message”) as content. The hub also translates the status message into a different communicates protocol. For example, if the hub receives an SIP message, the hub may translate the SIP message into an XMPP message, and vice versa. At 403, the monitoring system waits to receive a status message from the hub. If the monitoring system receives the status message via a second connector within a predefined time period, the monitoring system proceeds to 404 to analyze the content of the status message to determine the status of the hub and/or the other systems (e.g., relay server, transcoder, echo bot, various UC systems) that are in communication with the hub. The content of the status message is discussed further in the sections below. If the monitoring system times out waiting for a status message, the monitoring system proceeds to 405.

At 405, depending on the status information (or the lack thereof) and one or more predefined policies, the monitoring system may generate different alerts. According to one embodiment, the monitoring system may send an alert (e.g., via email) to a user to indicate potential status irregularities associated the hub and/or other systems (e.g., UC systems, relay server, transcoder, echo bot) in communication with the hub. According to another embodiment, the monitoring system may email a summary of the status information to the user if the monitoring system determines (at 404) that the status of the hub and/or the other systems has deteriorated or otherwise warrants the user's attention. According to another embodiment, the monitoring system may cause a pager alert (e.g., via a system that converts an email alert to a pager alert such as PagerDuty®) to be sent to the user if the monitoring system determines that the hub and/or the other systems are exhibiting critical issues.

At 406, the monitoring system stores the status information in a database, such as a time-series database. Storing the status information over time, for example, allows the user to analyze and identify potential failure trends, which may help the user to remediate and/or anticipate future failures. Older status information in the database may be time-compressed to make available more storage space for newer status information. According to one embodiment, the monitoring system provides a web-based user interface that allows users to retrieve and/or visualize (e.g., plot and chart) the time-series data in the database, such as to view trends in the status data.

FIG. 4 that illustrates the monitoring system may return to 401 to continually monitor (e.g., at configurable, regular intervals) the status of the hub and/or the other systems. Additionally, the monitoring system may alternate between sending messages using different protocols (e.g., sending an SIP message at time t=0, an XMPP message at t=1, an SIP at t=2, an XMPP message at t=3, etc.). Each message for requesting status information and its corresponding status message may include a counter that increments with each message sent and/or a timestamp. Including a counter and/or timestamp allows the monitoring system to correlate the status messages with the messages requesting status information as well as to correlate heartbeat emails and pager alerts (e.g., PagerDuty®) with messages in the log files of the hub and/or service checker.

According to one embodiment, the monitoring system may determine a level of hub latency using multiple thresholds and determine whether and/or how to alert a user based on the level of hub latency. For example, if the monitoring system receives a status message from the hub within 15 seconds after sending a message requesting status information, the monitoring system may not alert the user. If the monitoring system receives the status message between 15 seconds and 30 seconds, the monitoring system may alert the user of a potential irregularity via email. If the monitoring system receives the status message after 30 seconds, the monitoring system may send a pager alert (e.g., via PagerDuty®) to notify the user of a potentially serious issue.

### Content of a Status Message

As discussed above, the content of a response received from the hub generally includes status information for the hub and/or other systems (e.g., relay server, transcoder, echo bot, various UC systems) that are in communication with the hub. According to one embodiment, the status information may include information about memory usage, thread usage, unresponsive domains associated with UC systems and echo bots, latency information, transcoder usage, and/or the number of RTP sessions being hosted on the relay server. Monitoring a system's (e.g., hub, relay server, transcoder) memory and/or thread usage is generally desirable because high usage may indicate the need for provisioning more resources or indicate potentially abnormal system behavior. If usage continues to increase without provisioning more resources, the system may eventually crash. Monitoring unresponsive domains associated with UC systems is generally desirable because if a customer's UC system is not communicating properly with the hub, it should be resolved as soon as possible to mitigate inconveniences to the customer's users. Similarly, monitoring unresponsive domains associated with echo bots is generally desirable so that issues can be resolved as soon as possible to mitigate inconveniences to the customer's users who rely on the echo bots to test their connections. Monitoring latency is also generally desirable because high or increasing latency may indicate abnormal system behavior and pending crash. Monitoring the number of RTP sessions utilizing the transcoder may be desirable to anticipate future usage, for example, if the transcoder is licensed from a third-party and the license only allows a certain number of sessions at one time.

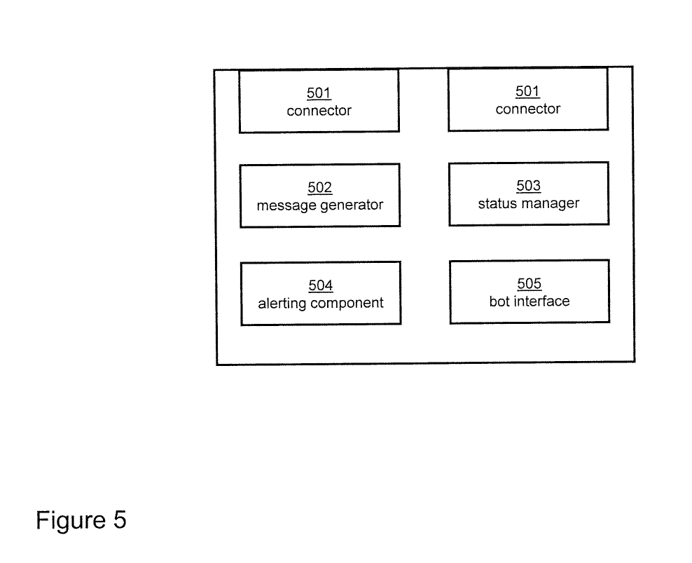

FIG. 5 illustrates a block diagram of an exemplary monitoring system, according to one embodiment. The monitoring system 500 may include connectors 501, a message generator 502, an status manager 503, an alerting component 504, and a bot interface 505. It is contemplated that these components may be combined or divided into sub-components and that the monitoring system and/or its components may be implemented using software elements, hardware elements, or a combination of software and hardware elements. Such variations are within the scope of the current disclosure.

Each of the connectors 501 may be associated with a corresponding communications protocol (e.g., SIP and XMPP) based on which the connectors 501 are configured to send and receive messages to the hub. The message generator 502 is configured to generate a message to request status information from the hub in each of the supported communications protocols. According to one embodiment, the message generator 502 provides an indicator in a message header to indicate to the hub that the message is a request for status information. The status manager 503 is configured to analyze status messages containing status information received from the hub in response to the messages requesting status information. Based on the status information received from the hub, the status manager may operate in accordance with one or more default or user-defined policies. For example, the status manager 503 may log the status information in a database according to one policy and/or request the alerting component 504 to send (or cause to send) alerts to one or more users according to another policy. The alerting component 504 may be configured to send various alerts, including heartbeat emails and pager alerts (e.g., via PagerDuty®). The bot interface 505 is configured to access the database of status information and to allow a hub administrator (with appropriate authorization) to retrieve status information from the database by initiating a chat session with the bot interface. For example, an administrator may request status information by sending a predefined command and applicable search/filter parameters (e.g., time, date, and status fields) as a chat message to the bot interface. The bot interface may reply with one or more chat message to provide status information satisfying the administrator's request parameters.

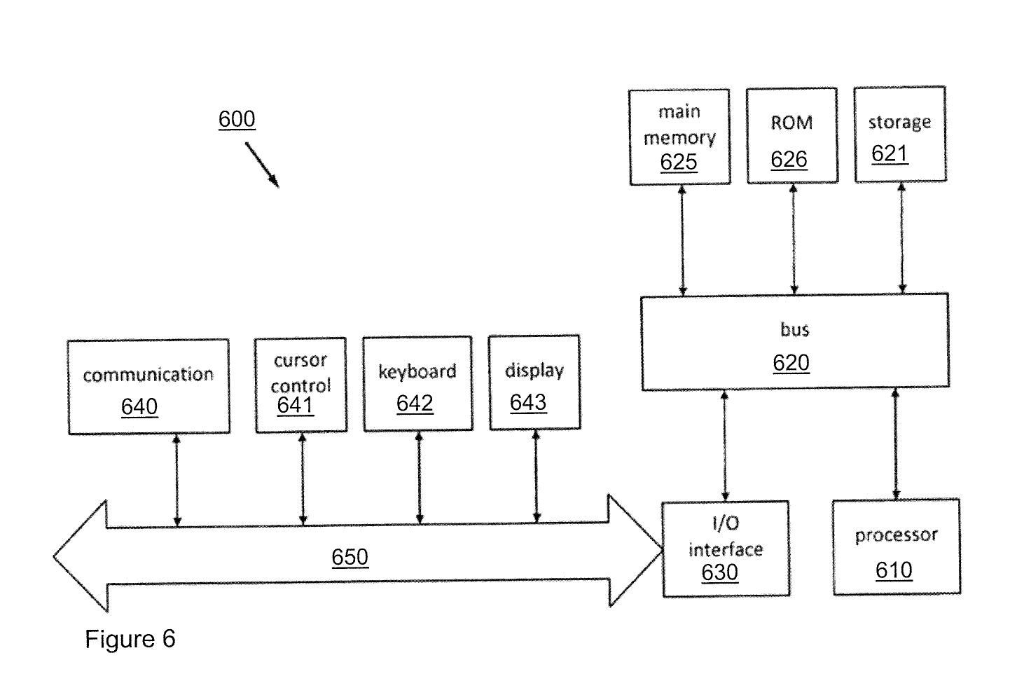

FIG. 6 illustrates an exemplary computer architecture that may be used for the present system, according to one embodiment. The exemplary computer architecture may be used for implementing one or more components described in the present disclosure including, but not limited to, the monitoring system. One embodiment of architecture 600 comprises a system bus 620 for communicating information, and a processor 610 coupled to bus 620 for processing information. Architecture 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 610. Architecture 600 may also include a read only memory (ROM) and/or other static storage device 626 coupled to bus 620 for storing static information and instructions used by processor 610.

A data storage device 625 such as a magnetic disk or optical disc and its corresponding drive may also be coupled to architecture 600 for storing information and instructions. Architecture 600 can also be coupled to a second I/O bus 650 via an I/O interface 630. A plurality of I/O devices may be coupled to I/O bus 650, including a display device 643, an input device (e.g., an alphanumeric input device 642 and/or a cursor control device 641).

The communication device 640 allows for access to other computers (e.g., servers or clients) via a network. The communication device 640 may comprise one or more modems, network interface cards, wireless network interfaces or other interface devices, such as those used for coupling to Ethernet, token ring, or other types of networks.

The advantages of the system disclosed herein are readily apparent. The present system and method monitors the status of the hub to detect existing issues and/or anticipate potential future issues.

We claim:

1. An apparatus for monitoring a hub-based federation system, the apparatus comprising:
a message generator configured to generate a first message based on a first communications protocol;
a first connector configured to send the first message to a hub via the first communications protocol, the hub federating a plurality of unified communications systems;
a second connector configured to receive a second message from the hub via a second communications protocol; and
a status manager configured to analyze the second message to determine status information regarding the hub-based federation system.

2. The apparatus of claim 1 wherein:
the message generator is also configured to generate the first message based on the second communications protocol;
the second connector is also configured to send the first message to the hub via the second communications protocol, and
the first connector is also configured to receive the second message from the hub via the first communications protocol.

3. The apparatus of claim 2 wherein the first and second connectors are configured to continually alternate between sending the first message and receiving the second message.

4. The apparatus of claim 1 wherein the first message includes a header that indicates to the hub that the first message is a request for status information.

5. The apparatus of claim 1, further comprising an alerting component configured to cause an alert to be sent to a user based on the status information.

6. The apparatus of claim 5 wherein the alerting component is also configured to send a heartbeat email to the user at regular intervals.

7. The apparatus of claim 5 wherein the alert is a pager alert converted from an email alert.

8. The apparatus of claim 1 wherein the status information includes status information regarding the hub.

9. The apparatus of claim 1 wherein the status information includes status information regarding at least one of a unified communications system, a relay server, a transcoder, and an echo bot connected to the hub.

10. The apparatus of claim 1, further comprising a bot interface configured to provide the status information to an administrator of the hub-based federation system via a chat session.

11. The apparatus of claim 1 wherein the first communications protocol is SIP and the second communications protocol is XMPP.

12. The apparatus of claim 1 wherein the first communications protocol is XMPP and the second communications protocol is SIP.

13. The apparatus of claim 1 wherein the second message is at least partially translated from the first message.

14. The apparatus of claim 1 wherein the first and second connectors are each associated with one or more unique domain addresses.

15. The apparatus of claim 1 wherein the status manager is also configured to store the status information as data into a database.

16. The apparatus of claim 15, further comprising a web-based user interface that allows users to visualize the data in the database.

17. A method for monitoring a hub-based federation system, the method comprising:
generating a first message based on a first communications protocol;
sending the first message to a hub via the first communications protocol, the hub federating a plurality of unified communications systems;
receiving a second message from the hub via a second communications protocol; and
analyzing the second message to determine status information regarding the hub-based federation system.

18. The method of claim 17 further comprising:
generating a third message based on the second communications protocol;
sending the third message via the second communications protocol;
receiving the fourth message from the hub via a second communications protocol; and
analyzing the fourth message to determine status information regarding the hub-based federation system.

19. The method of claim 17, further comprising causing an alert to be sent to a user based on the status information.

20. The method of claim 17, further comprising sending a heartbeat email to the user at regular intervals.

21. The method of claim 19 wherein the alert is a pager alert converted from an email alert.

22. The method of claim 17 wherein the status information includes status information regarding the hub.

23. The method of claim 17 wherein the status information includes status information regarding at least one of a unified communications system, a relay server, a transcoder, and an echo bot connected to the hub.

24. The method of claim 17, further comprising providing a bot interface that provides the status information to an administrator of the hub-based federation system via a chat session.

25. The method of claim 17 wherein the first communications protocol is SIP and the second communications protocol is XMPP.

26. The method of claim 17 wherein the first communications protocol is XMPP and the second communications protocol is SIP.

27. The method of claim 17 wherein the second message is at least partially translated from the first message.

28. The method of claim 17 wherein the first message includes a header that indicates to the hub that the first message is a request for status information.

29. The method of claim 17, further comprising storing the status information as data into a database.

30. The method of claim 29, further comprising providing a web-based user interface that allows users to visualize the data in the database.
